(19) United States
(12) Patent Application Publication
(10) Pub. No.: US 2019/0277413 A1
(43) Pub. Date: Sep. 12, 2019

(54) PUSH BUTTON SWITCHING SPOOL

(71) Applicant: Runner (Xiamen) Corp., Xiamen (CN)

(72) Inventors: ZHI-SHENG LI, Xiamen (CN); SHENG-CHAO DAI, Xiamen (CN); CAN-KUN WU, Xiamen (CN); QING-PING WANG, Xiamen (CN)

(21) Appl. No.: 16/295,872

(22) Filed: Mar. 7, 2019

(30) Foreign Application Priority Data
Mar. 9, 2018 (CN) 201810194516.2

(51) Int. Cl. F16K 11/065; F16K 27/04

(52) U.S. Cl. CPC F16K 11/065; F16K 27/04

(57) ABSTRACT

A push button switching spool includes a switching body. The switching body includes a housing, a water inlet and a water outlet, wherein the housing comprises an upper casing and a lower casing with a gap for passing water. A mandrel is disposed in the housing, and the mandrel axially moved within the housing. The mandrel comprises a plurality of grooves with sealing rings. And, a left protrusion and a right protrusion are formed on each groove, wherein a diameter of the left protrusion is the same as a diameter of the right protrusion. The push button switching spool can normally switch water paths at high water pressure.

### BACKGROUND OF THE INVENTION

### Field of the Invention

The present invention relates to a switching spool, particularly to a push button switching spool, and more particularly to a push button switching spool that can be used to switch water passages.

### Description of the Prior Art

As well known to those skilled in the art, when the water pressure exceeds 80 PSI, the traditional push button switching spool cannot be normally switched, and the switching force will increase as the water pressure increases. The force value is too high to meet the standard of the use and the pressing feel is not good. In the condition of suspending the water, when the outlet end of the push button switching spool is connected to a top spray or a shower with a water-suspending function, the push button switching spool cannot be normally switched at water pressure exceeding 45 PSI.

### SUMMARY OF THE INVENTION

An objective of the present invention is to solve the above-mentioned problems and to provide a push button switching spool, which can normally switch water paths at high water pressure.

The present invention achieves the above-indicated objective by providing a push button switching spool. The push button switching spool comprises a switching body. The switching body includes a housing, a water inlet and a water outlet, wherein the housing comprises an upper casing and a lower casing with a gap for passing water. A mandrel is disposed in the housing, and the mandrel axially moved within the housing. The mandrel comprises a plurality of grooves with sealing rings. And, a left protrusion and a right protrusion are formed on the each groove, wherein a diameter of the left protrusion is the same as a diameter of the right protrusion. A restoring spring is disposed between the mandrel and the lower casing. A rotating member with a first spring tooth is connected with the mandrel, wherein one end of the mandrel is covered by the lower casing and the other end of the mandrel is covered by the upper casing. A built-in button is coupled with the rotating member, wherein the built-in button comprises a second spring tooth cooperating with the first spring tooth. And, a step surface for contacting the first spring tooth is disposed in the upper casing.

In the embodiments of the present invention, the switching body comprise a water inlet, a first water outlet and a second water outlet.

In the embodiments of the present invention, the grooves are a first groove, a second groove and a third groove, and wherein the left protrusion of the first groove is a first protrusion, and the right protrusion of the first groove is a second protrusion, and the right protrusion of the second groove is a third protrusion, and the left protrusion of the third groove is a fourth protrusion.

In the embodiments of the present invention, the upper casing comprises a first step surface and a second step surface, and the height of the first step surface is less than the height of the second step surface.

In the embodiments of the present invention, the first step surface is a plane, and the second step surface is a slope.

In the embodiments of the present invention, the switching body comprises a lock nut with a first external thread, and a first internal thread disposed in the upper casing matched with the first external thread.

In the embodiments of the present invention, the mandrel comprises a first plug connector, and the lower casing comprises a first sinking groove, and wherein one end of the restoring spring is placed in the first sinking groove and the other end is mated with the first plug connector.

In the embodiments of the present invention, the mandrel comprises a second plug connector, and the rotating member comprises a second sinking groove, and wherein the second plug connector is inserted into the second sinking groove for mating connection between the mandrel and the rotating member.

In the embodiments of the present invention, a first water stop is disposed between the lower casing and the switching body, a second water stop is disposed between the upper casing and the switching body, and a third water stop is disposed between the upper casing and the lower casing.

Compared to traditional push button switching spools, the present invention has several advantages. First, the present invention is to ensure that the sealing cross-sectional area of the push button switching spool is the same, so that the water pressure on both sides of the protrusions is the same. When the mandrel is switched, the pressing force does not increase with the increase of the water pressure. Additionally, the push button switching spool is sealed with annular seal rings for good sealing effect and simple assembly.

### BRIEF DESCRIPTION OF THE DRAWINGS

FIG. 1 is an exploded view of a push button switching spool of the present invention.

FIG. 2 is a cross-sectional view showing the second water passage in an embodiment of the present invention.

FIG. 3 is a cross-sectional view showing the first water passage in an embodiment of the present invention.

FIG. 4 is a top cross-sectional view of the housing of the present invention.

FIG. 5 is an enlarged schematic view of the built-in button of the present invention.

FIG. 6 is an enlarged schematic view of the rotating member of the present invention.

FIG. 7 is an enlarged schematic view of the upper casing of the present invention.

FIG. 8 is an enlarged schematic view of the mandrel of the present invention.

### DETAILED DESCRIPTION OF THE PREFERRED EMBODIMENTS

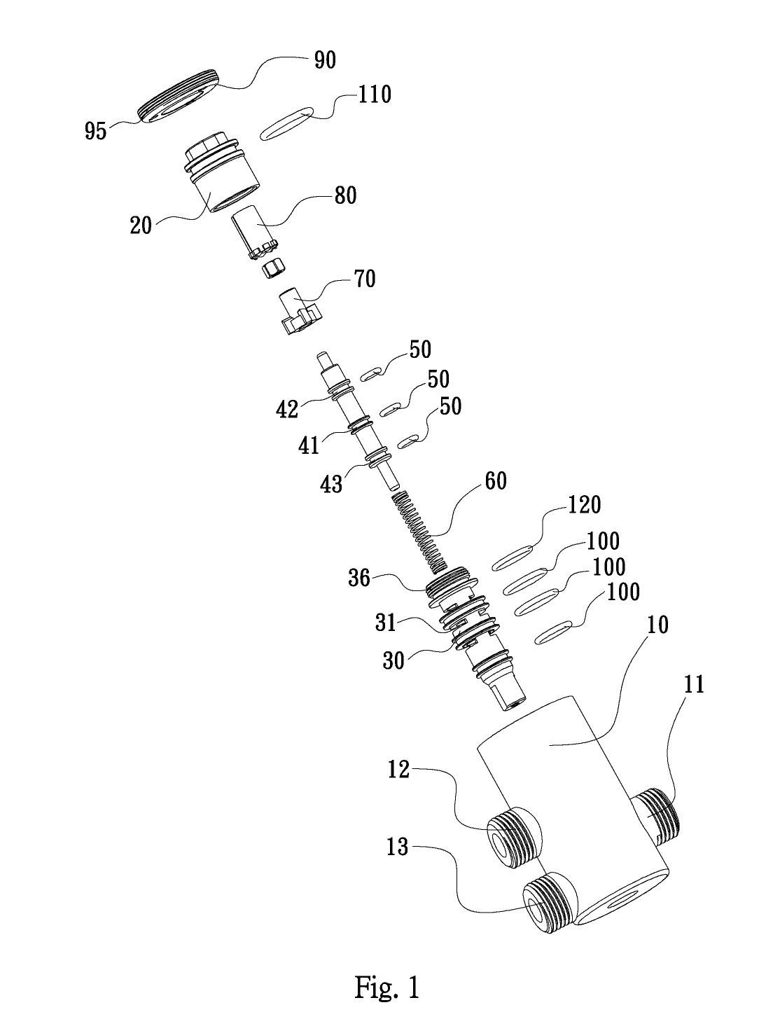

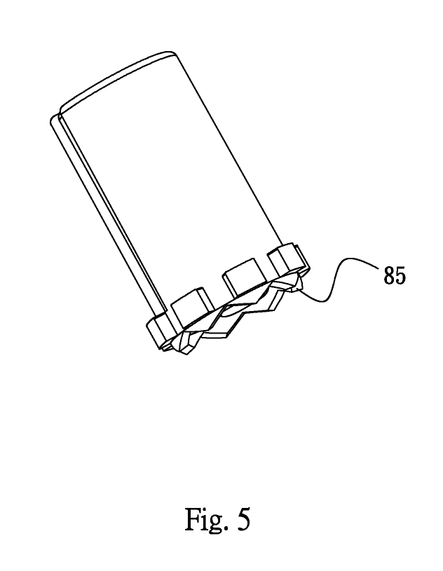

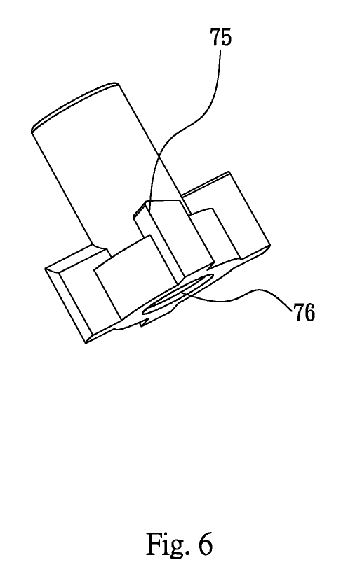

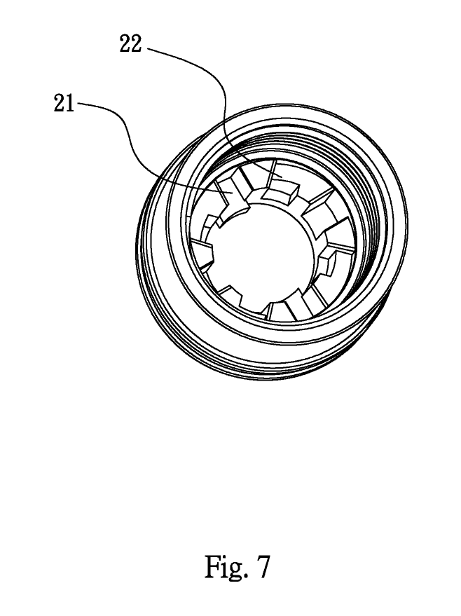

Referring to FIGS. 1-8, of the present invention, a push button switching spool includes a switching body 10. The switching body 10 includes a water inlet 11 and a water outlet. The switching body 10 has a housing. The housing includes an upper casing 20 and a lower casing 30. The upper casing 20 includes a second internal thread 26, and the lower casing 30 includes a second external thread 36. The second internal thread 26 is mated with the second external thread 36 to fix the upper casing 20 and the lower casing 30. A mandrel 40 is disposed in the upper casing 20 and the lower casing 30 of the housing, the mandrel 40 is axially moved within the housing, and the mandrel 40 includes a plurality of grooves, as shown in FIGS. 1-4. The grooves include left protrusions and right protrusions, a diameter of the left protrusions is the same as a diameter of the right protrusions. The grooves include a plurality of sealing rings 50. One end of the mandrel 40 is covered by a lower casing 30, and the other end of the mandrel 40 is covered by the upper casing 20. A restoring spring 60 is disposed between the mandrel 40 and the lower casing 30, as shown in FIGS. 1-4. The other end of the mandrel 40 is connected with a rotating member 70, and the rotating member 70 includes a first spring tooth 75, as shown in FIGS. 1 and 6. The rotating member 70 is coupled with a built-in button 80, and the built-in button 80 includes a second spring tooth 85 that cooperates with the first spring tooth 75, as shown in FIGS. 1, 5 and 6. Step surfaces for contacting the first spring tooth 75 are disposed in the upper casing 20. The lower casing 30 includes a gap 31 for passing water.

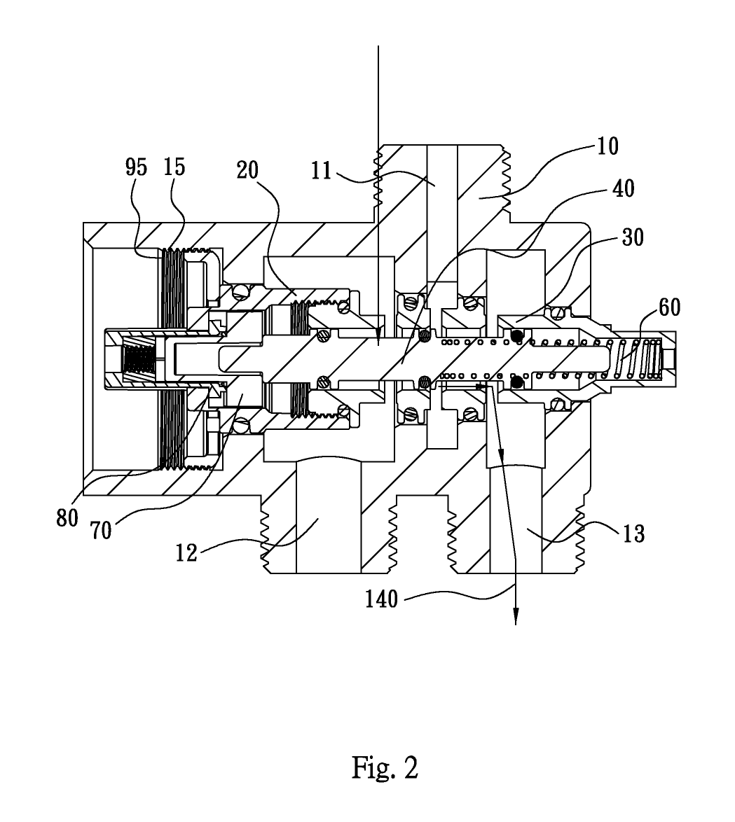

Next, the switching body 10 is provided with the water inlet 11 and two water outlets. The two water outlets are a first water outlet 12 and a second water outlet 13. The water inlet 11 is a water inlet channel of the water path. The water path enters the switching body 10 from the water inlet 11. Under the interaction of the mandrel 40 as well as the upper casing 20 and the lower casing 30, the water path may optionally flow out of the first water outlet 12 or out of the second water outlet 13, as shown in FIGS. 1 and 2.

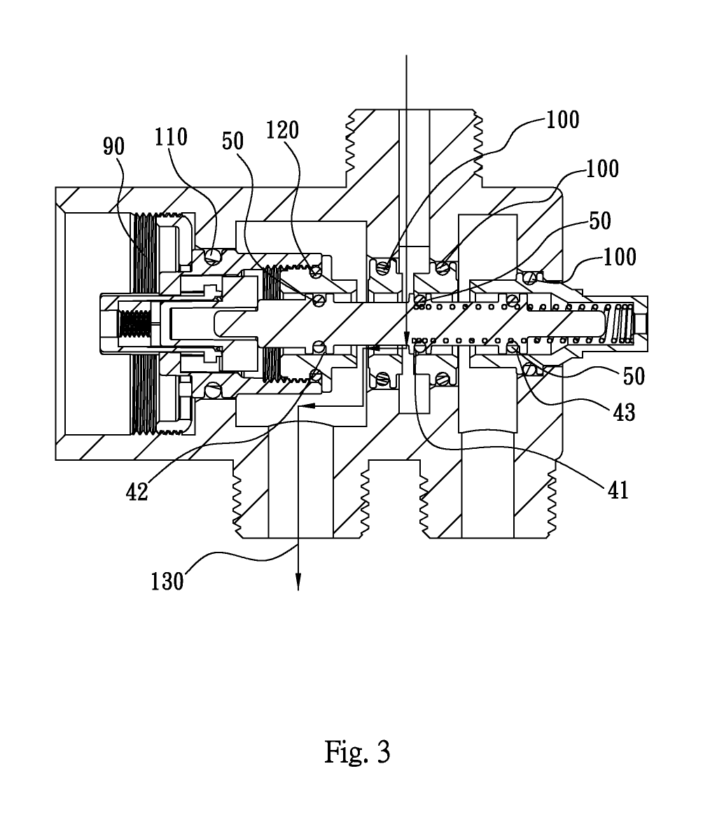

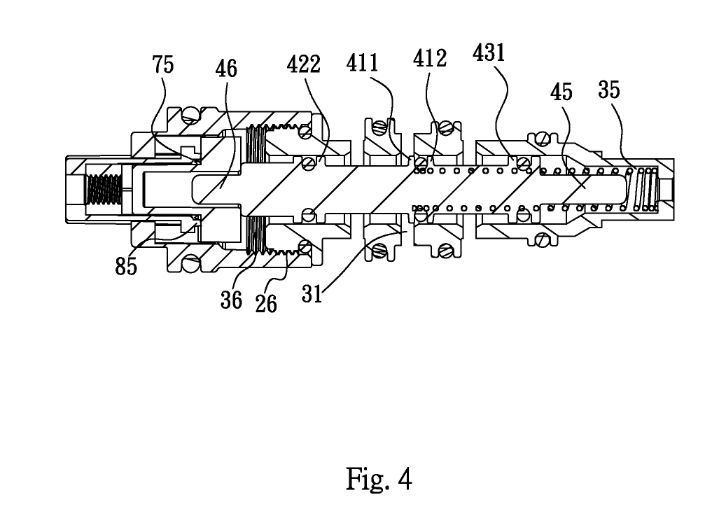

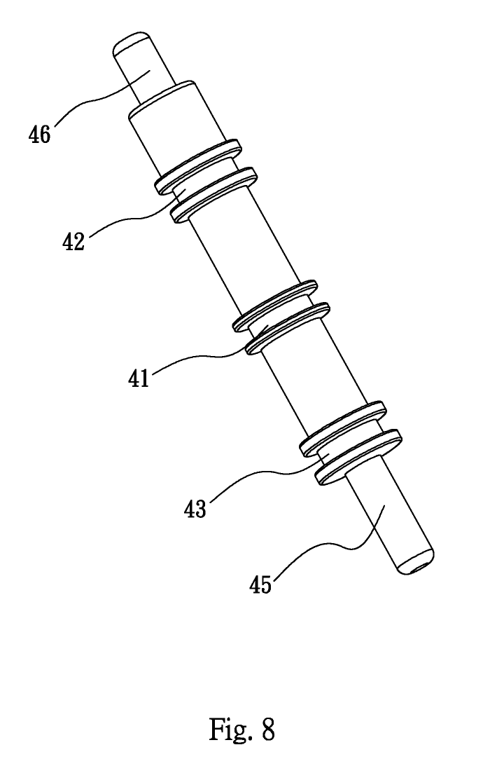

Furthermore, the mandrel 40 includes three grooves, which are a first groove 41, a second groove 42, and a third groove 43, respectively. The left protrusion of the first groove 41 is a first protrusion 411, and the right protrusion of the first groove is a second protrusion 412. The right protrusion of the second groove 42 is a third protrusion 422, and the left protrusion of the third groove 43 is a fourth protrusion 431, as shown in FIGS. 4 and 8. When the first protrusion 411 is located at the right end of the gap 31, a first water passage 130 is formed, and the water path flows out from the first water outlet 12, as shown in FIGS. 3 and 4. When the second protrusion 412 is located at the left end of the gap 31, a second water passage 140 is formed, and the water path flows out from the second water outlet 13, as shown in FIGS. 2 and 4.

Moreover, the diameter of the first protrusion 411 is the same as the diameter of the third protrusion 422, and the diameter of the second protrusion 412 is the same as the diameter of the fourth protrusion 431. The diameters of the above-mentioned protrusions 411,412, 422 and 431 are the same, and the function is to ensure that the sealing cross-sectional area of the push button switching spool is the same, so that the water pressures on both sides of the protrusions 411,412, 422 and 431 are the same. When the mandrel 40 is switched, a pressing force does not increase with the increase of a water pressure. In the condition of suspending the water, when the outlet end of the push button switching spool is connected to a top spray or a shower with a water-suspending function, the mandrel 40 can be normally switched, and the switching forces are not affected, regardless operating push button at low water pressures or at high water pressures.

Next, the upper casing 20 includes a first step surface 21 and a second step surface 22. The height of the first step surface 21 is less than the height of the second step surface 22. The function of the arrangement of the first step surfaces 21 and the second step surface 22 is to change the position of the mandrel 40 within the upper casing 20. When the first spring tooth 75 is located on the second step surface 22, the first protrusion 411 is located at the right end of the gap 31, and the water path is the first water passage 130, as shown in FIGS. 3, 4, 6 and 7. When the first spring tooth 75 is located on the first step surface 21, the second protrusion 412 is located at the left end of the gap 31, and the water path is the second water passage 140, as shown in FIGS. 2, 4, 6 and 7.

Next, the first step surface 21 is a plane, and the second step surface 22 is a slope. The second step surface 22 is a sloped surface to enable the mandrel 40 to be gradually over-switched when the water passages 130 and 140 are switched, and the operation is smooth.

Next, the switching body 10 includes a lock nut 90, and the lock nut 90 is provided with a first external thread 95. The switching body 10 has a first internal thread 15 matched with the first external thread 95, as shown in FIGS. 1-2. The lock nut 90 ensures that the upper casing 20 and the mandrel 40 are stable within the switching body 10.

Next, the mandrel 40 includes a first plug connector 45. The lower casing 30 includes a first sinking groove 35. One end of the restoring spring 60 is placed in the first sinking groove 35 and the other end of the restoring spring 60 is mated with the first plug connector 45.

Next, the mandrel 40 includes a second plug connector 46. The rotating member 70 includes a second sinking groove 76. The second plug connector 46 is inserted into the second sinking groove 76 to form a mating connection between the mandrel 40 and the rotating member 70, as shown in FIGS. 6 and 8.

Next, A first water stop 100 is disposed between the lower casing 30 and the switching body 10. A second water stop 110 is disposed between the upper casing 20 and the switching body 10. A third water stop 120 is disposed between the upper casing 20 and the lower casing 30. The function of the above water stops 100, 110 and 120 is to ensure the sealing of the push button switching spool.

When the water path enters the switching body 10 from the water inlet 11, the water path may optionally flow out of the first water outlet 12 or out of the second water outlet 13 under the interaction of the mandrel 40 and the lower casing 30. The water path flows out of the first water outlet 12 as a first water passage 130, and the water path flows out of the second water outlet 13 as a second water passage 140, as shown in FIGS. 2 and 3.

Finally, when the water passage is the first water passage 130, the first spring tooth 75 of the rotating member 70 are located on the second step surface 22 of the upper casing 20. When the mandrel 40 moves to the right and the restoring spring 60 is compressed, the first protrusion 411 is located at the right end of the gap 31, as shown in FIGS. 3-4. When the built-in button 80 is pressed and the second spring tooth 85 of the built-in button 80 interacts with the first spring tooth 75, the rotating member 70 rotates as well as the first spring tooth 75 is changed into a mating engagement with first step surface 21 from the second step surface 22 of the upper casing 20, under the interaction of the second spring tooth 85 and the first spring tooth 75. And, where the mandrel 40 moves to the left and the restoring spring 60 is reset, the second protrusion 412 of the mandrel 40 is located at the left end of the gap 31, and the water path is the second water passage 140, as shown in FIGS. 2 and 4.

The above is only the preferred embodiment of the present invention, and it is of course not possible to limit the scope of the present invention. Accordingly, equivalent changes made in the claims of the invention are still within the scope of the invention.

What is claimed is:

1. A push button switching spool, comprising:
a switching body, having a housing, a water inlet and a water outlet, wherein the housing comprises an upper casing and a lower casing with a gap for passing water;
a mandrel, disposed in the housing, the mandrel axially moved within the housing, wherein the mandrel comprises a plurality of grooves with sealing rings; and
a left protrusion and a right protrusion, formed on the each groove, wherein a diameter of the left protrusion is the same as a diameter of the right protrusion.

2. The push button switching spool as recited in claim 1, further comprising:
a restoring spring, disposed between the mandrel and the lower casing;
a rotating member with a first spring tooth, connected with the mandrel, wherein one end of the mandrel is covered by the lower casing and the other end of the mandrel is covered by the upper casing;
a built-in button, coupled with the rotating member, wherein the built-in button comprises a second spring tooth cooperating with the first spring tooth; and
a step surface for contacting the first spring tooth, disposed in the upper casing.

3. The push button switching spool as recited in claim 1, wherein the switching body comprise a water inlet, a first water outlet and a second water outlet.

4. The push button switching spool as recited in claim 3, wherein the grooves are a first groove, a second groove and a third groove, and wherein the left protrusion of the first groove is a first protrusion, and the right protrusion of the first groove is a second protrusion, and the right protrusion of the second groove is a third protrusion, and the left protrusion of the third groove is a fourth protrusion.

5. The push button switching spool as recited in claim 4, wherein a diameter of the first protrusion is the same as a diameter of the third protrusion, and a diameter of the second protrusion is the same as a diameter of the fourth protrusion.

6. The push button switching spool as recited in claim 2, wherein the upper casing comprises a first step surface and a second step surface, and the height of the first step surface is less than the height of the second step surface.

7. The push button switching spool as recited in claim 6, wherein the first step surface is a plane, and the second step surface is a slope.

8. The push button switching spool as recited in claim 1, wherein the switching body comprises a lock nut with a first external thread, and a first internal thread matched with the first external thread.

9. The push button switching spool as recited in claim 2, wherein the mandrel comprises a first plug connector, and the lower casing comprises a first sinking groove, and wherein one end of the restoring spring is placed in the first sinking groove and the other end is mated with the first plug connector.

10. The push button switching spool as recited in claim 2, wherein the mandrel comprises a second plug connector, and the rotating member comprises a second sinking groove, and wherein the second plug connector is inserted into the second sinking groove for mating connection between the mandrel and the rotating member.

11. The push button switching spool as recited in claim 1, wherein a first water stop is disposed between the lower casing and the switching body, a second water stop is disposed between the upper casing and the switching body, and a third water stop is disposed between the upper casing and the lower casing.
